(19) United States
(12) Patent Application Publication
(10) Pub. No.: US 2016/0094837 A1
(43) Pub. Date: Mar. 31, 2016

(54) DISTRIBUTED STEREOSCOPIC RENDERING FOR STEREOSCOPIC PROJECTON AND DISPLAY

(71) Applicant: 3DOO, Inc., New York, NY (US)

(72) Inventor: Ingo Nadler, New York, NY (US)

(73) Assignee: 3DOO, Inc., New York, NY (US)

(21) Appl. No.: 14/501,249

(22) Filed: Sep. 30, 2014

(51) Int. Cl. H04N 13/04; G06F 3/01

(52) U.S. Cl. CPC H04N 13/0484; G06F 3/011; H04N 13/044; H04N 13/0481

(57) ABSTRACT

A method of generating stereoscopic images includes receiving a call from an application programming interface (API) via at least one communication channel of a network, intercepting the call, via the network, transmitting the call to at least one remote computing device, modulating the call to match a user's head position and direction, generating left and right perspective views, rendering outputs of the left and right perspective views, and forwarding the outputs, via the network, to a graphics processing unit. The left and right perspective views are displayed on display hardware, such as power walls and/or 3D caves and/or wearable stereoscopic display devices.

### BACKGROUND

1. Technical Field

The present disclosure relates to stereoscopic image representation. More particularly, the present disclosure relates to a system and method for enabling any 3D simulation or industry application to be displayed stereoscopically on, for example, a power wall or a 3D cave.

2. Description of Related Art

Three dimensional views are created because each eye sees the world from a slightly different vantage point. Distance to objects is then perceived by the depth perception process which combines the signals from each eye. Depth perception is simulated by computer displays and projection systems.

Stereoscopic representation involves presenting information for different pictures, one for each eye. The result is the presentation of at least two stereoscopic pictures, one for the left eye and one for the right eye. Stereoscopic representation systems often work with additional accessories for the user, such as active or passive 3D eyeglasses. Auto-stereoscopic presentation is also possible, which functions without active or passive 3D eyeglasses.

Passive polarized eyeglasses are commonly used due to their low cost of manufacture. Polarized eyeglasses use orthogonal or circular polarizing filters to extinguish right or left handed light from each eye, thus presenting only one image to each eye. Use of a circular polarizing filter allows the viewer some freedom to tilt their head during viewing without disrupting the 3D effect.

Active eyeglasses such as Shutter eyeglasses are commonly used due to their low cost of manufacture. Shutter eyeglasses consist of a liquid crystal blocker in front of each eye which serves to block or pass light through in synchronization with the images on the computer display, using the concept of alternate-frame sequencing.

Stereoscopic pictures, which yield a stereo pair, are provided in a fast sequence alternating between left and right, and then switched to a black picture to block the particular eye's view. In the same rhythm, the picture is changed on the output display device (e.g., screen or monitor). Due to the fast picture changes (often at least 25 times a second), the observer has the impression that the representation is simultaneous and this leads to the creation of a stereoscopic 3D effect.

What is needed is a method and system capable of converting current simulator software or simulator software output to provide stereoscopic 3D displays, which is easy to implement across a variety of application software, does not require rewriting of each existing software platform, and presents a high quality user experience.

### SUMMARY

Embodiments of the present disclosure are described in detail with reference to the drawing figures wherein like reference numerals identify similar or identical elements.

An aspect of the present disclosure provides a method of generating stereoscopic images, the method including the steps of receiving a call from an application programming interface (API) via one or more communication channels of a network, intercepting the call, via the network, transmitting the call to a remote computing device, modulating the call to match a user's head position and direction, generating left and right perspective views, rendering outputs of the left and right perspective views, and forwarding the outputs, via the network, to a graphics processing unit.

Another aspect of the present disclosure provides displaying the left and right perspective views on display hardware.

In one aspect, the display hardware is a power wall. Alternatively, the display hardware is a 3D cave. Alternatively, the display hardware is both one or more power walls and a 3D cave. In a further aspect, the display hardware is a number of wearable stereoscopic display devices worn by one or more users.

In another aspect, the API is a three-dimensional API.

In yet another aspect, the remote computing device includes one or more processors.

In another aspect, the call is transmitted to the remote computing device with control data.

In yet another aspect, the left and right perspective views are stereoscopic views.

In exemplary embodiments of the present disclosure, the call is transformed into calls for left and right edge blended stereoscopic views. Alternatively, the call is transformed into calls for left and right geometry warped stereoscopic views. Alternatively, the call is transformed into calls for left and right interleaved stereoscopic views.

Another aspect of the present disclosure provides a system for generating stereoscopic images, the system including a network having one or more communication channels, an application which generates monoscopic calls, an application programming interface (API) for sending a call, via the network, an intercepting module for intercepting the call, via the network, a remote computing device for receiving the call from the intercepting module, a modulator for modulating the call to match a user's head position and direction, a processing module for generating left and right perspective views, and an output module for rendering outputs of the left and right perspective views and forwarding the outputs, via the network, to a graphics processing unit.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

### BRIEF DESCRIPTION OF THE DRAWING

Various embodiments of the present disclosure are described herein below with references to the drawings, wherein:

FIG. 1 is a system for converting application software graphics output into stereoscopic 3D, where the 3D stereoscopic module follows the application programming interface, in accordance with embodiments of the present disclosure;

FIG. 2 is a system for converting application software graphics output into stereoscopic 3D, where the 3D stereoscopic module precedes the application programming interface, in accordance with embodiments of the present disclosure;

FIG. 3 is a flowchart depicting a process for converting application software graphics output into stereoscopic 3D, in accordance with embodiments of the present disclosure;

FIG. 4 is a block diagram for converting application software graphics output into stereoscopic 3D via an interceptor that transmits the calls to one or more remote computing devices, in accordance with embodiments of the present disclosure; and

FIG. 5 is a system illustrating a user within a 3D cave or facing one or more power walls, the system continuously tracking the user's head position and direction, and communicating with the remote computing devices via the interceptor, in accordance with embodiments of the present disclosure.

The figures depict embodiments of the present disclosure for purposes of illustration only. One skilled in the art will readily recognize from the following disclosure that alternative embodiments of the structures and methods illustrated herein may be employed without departing from the principles of the present disclosure described herein.

### DETAILED DESCRIPTION

Although the present disclosure will be described in terms of specific embodiments, it will be readily apparent to those skilled in this art that various modifications, rearrangements and substitutions may be made without departing from the spirit of the present disclosure. The scope of the present disclosure is defined by the claims appended hereto.

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

Stereoscopic view refers to a perceived image that appears to encompass a 3-dimensional (3D) volume. To generate the stereoscopic view, a device displays two images on a 2-dimensional (2D) area of a display. These two images include substantially similar content, but with slight displacement along the horizontal axis of one or more corresponding pixels in the two images. The simultaneous viewing of these two images, on a 2D area, causes a viewer to perceive an image that is popped out of or pushed into the 2D display that is displaying the two images. In this way, although the two images are displayed on the 2D area of the display, the viewer perceives an image that appears to encompass the 3D volume.

The two images of the stereoscopic view are referred to as a left-eye image and a right-eye image, respectively. The left-eye image is viewable by the left eye of the viewer, and the right-eye image is not viewable by the left eye of the viewer. Similarly, the right-eye image is viewable by the right eye of the viewer, and the left-eye image is not viewable by the right eye of the viewer. For example, the viewer may wear specialized glasses, where the left lens of the glasses blocks the right-eye image and passes the left-eye image, and the right lens of the glasses blocks the left-eye image and passes the right-eye image.

Because the left-eye and right-eye images include substantially similar content with slight displacement along the horizontal axis, but are not simultaneously viewable by both eyes of the viewer (e.g., because of the specialized glasses), the brain of the viewer resolves the slight displacement between corresponding pixels by commingling the two images. The commingling causes the viewer to perceive the two images as an image with 3D volume.

In order to provide a hardware independent conversion of monocular and non-stereoscopic 3D graphics to stereoscopic 3D signals capable of being displayed on existing projection and display systems, a further application or module (hereinafter “stereoscopic 3D module”) is provided between the graphics driver and the application or can be incorporated into the application code itself.

The application can be any simulator or other software application (hereinafter also “simulator application” or “application”) which displays graphics, for example, a flight simulator, ship simulator, land vehicle simulator, or game. The graphics driver (hereinafter also “driver”) can be any graphics driver for use with 3D capable hardware, including standard graphics drivers. The 3D stereoscopic module is preferably implemented by software means, but may also be implemented by firmware or a combination of firmware and software.

In exemplary embodiments of the present disclosure, which are further described below, the stereoscopic 3D module may reside between the application and the application programming interface (API) or between the API and the driver or can itself form part of an API. One skilled in the art may contemplate various system configurations for incorporating the 3D stereoscopic module within the stereoscopic system.

The stereoscopic 3D module has means for receiving a call from the application, examining the received call, processing the received call and forwarding the received call or processed calls. The “examination” refers to examining the received call to determine whether it is a call which should be performed separately for each of the stereoscopic pictures in order to generate stereoscopic views and thus should be further processed. Examples of such a call include calls for monoscopic objects. If the “examination” means determines that the call should be further processed, the call is processed by processing means which converts the call into calls for each left and right stereoscopic picture and forwards the 3D stereoscopic calls to the driver. If the examining means determines that the call does not need further processing, for example if it is not an image call, or if it is already a 3D stereoscopic call, then the call is forwarded to the driver by forwarding means.

An exemplary embodiment of the present disclosure is now presented with reference to the creation of a 3D stereoscopic scene in a computer simulation, which is to be understood as a non-limiting example. In a typical computer simulation, a scene is presented on the output device by first creating a three dimensional model by means of a modeling method. This three dimensional model is then represented on a two-dimensional virtual picture space, creating a two dimensional virtual picture via a method referred to as transformation. Lastly, a raster conversion method is used to convert the virtual picture on a raster oriented output device, such as a computer monitor.

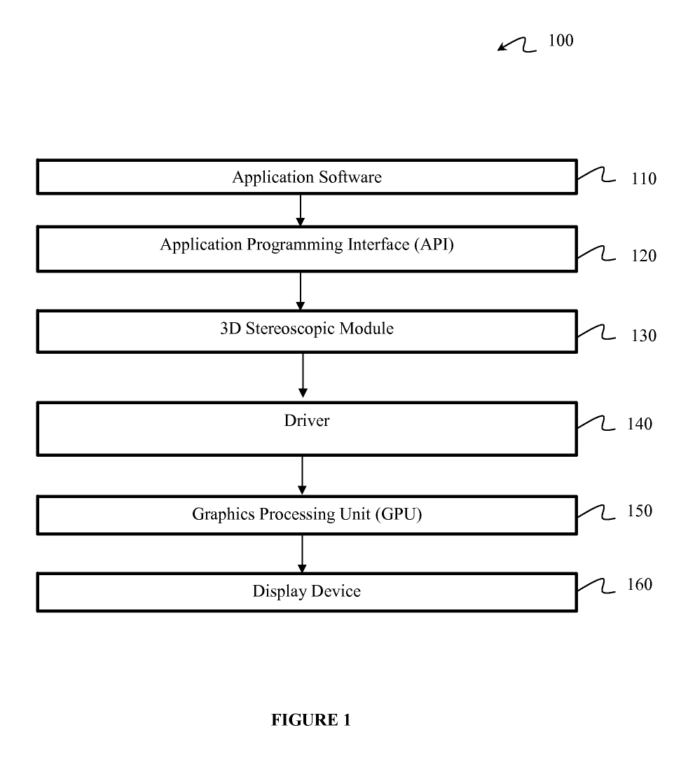

FIG. 1 is a system for converting application software graphics output into stereoscopic 3D, where the 3D stereoscopic module follows the application programming interface, in accordance with embodiments of the present disclosure.

The system 100 includes application software 110, an application programming interface (API) 120, a 3D stereoscopic module 130, a driver 140, a graphics processing unit 150, and a display device 160.

In particular, in a non-3D stereoscopic application, for example a monoscopic application, monoscopic calls are sent from the application programming interface 120 to the driver 140. In exemplary embodiments of the present disclosure, the 3D stereoscopic module 130 receives the monoscopic driver calls before they reach the driver 140. The calls are then processed into device independent stereoscopic calls. After processing by the 3D stereo module 130, the calls are delivered to the driver 140, which converts them into device dependent hardware calls, via a graphics processing unit (GPU) 150, which cause a 3D stereoscopic picture to be presented on the display device 160, for example a raster or projector display device.

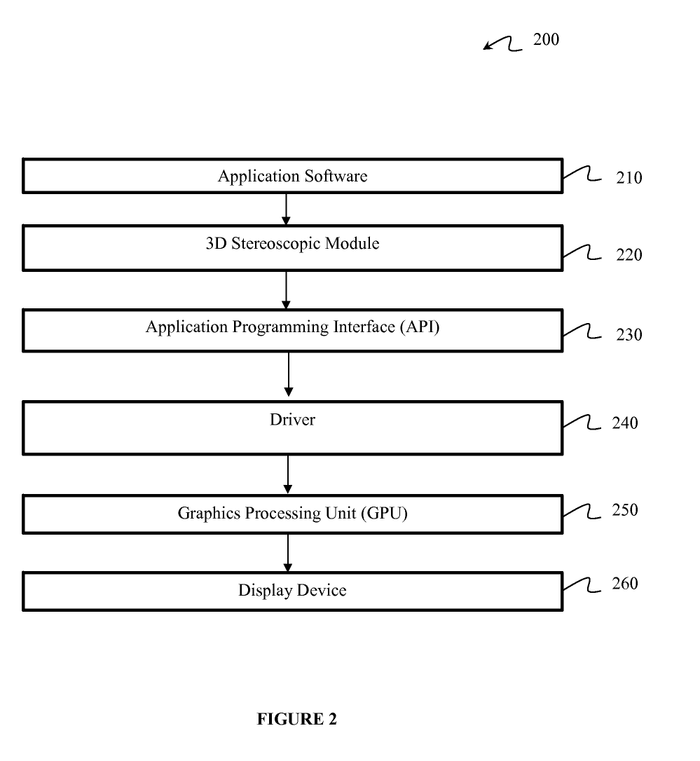

FIG. 2 is a system for converting application software graphics output into stereoscopic 3D, where the 3D stereoscopic module precedes the application programming interface, in accordance with embodiments of the present disclosure.

The system 200 includes application software 210, a 3D stereoscopic module 220, an application programming interface (API) 230, a driver 240, a graphics processing unit 250, and a display device 260. In this exemplary embodiment, the 3D stereo module 220 is located between the application software 210 and the application programming interface 230, and thus delivers 3D stereo calls to the application programming interface 230, which then communicates with the driver 240 which in turn controls the graphics processing unit 250 in order to display the data or information on the display device 260.

Therefore, FIG. 1 reflects on how the process works on the local machine for applications that are unaware of the stereoscopic module 130, whereas FIG. 2 describes how the process works for applications accessing the stereoscopic module 220 directly.

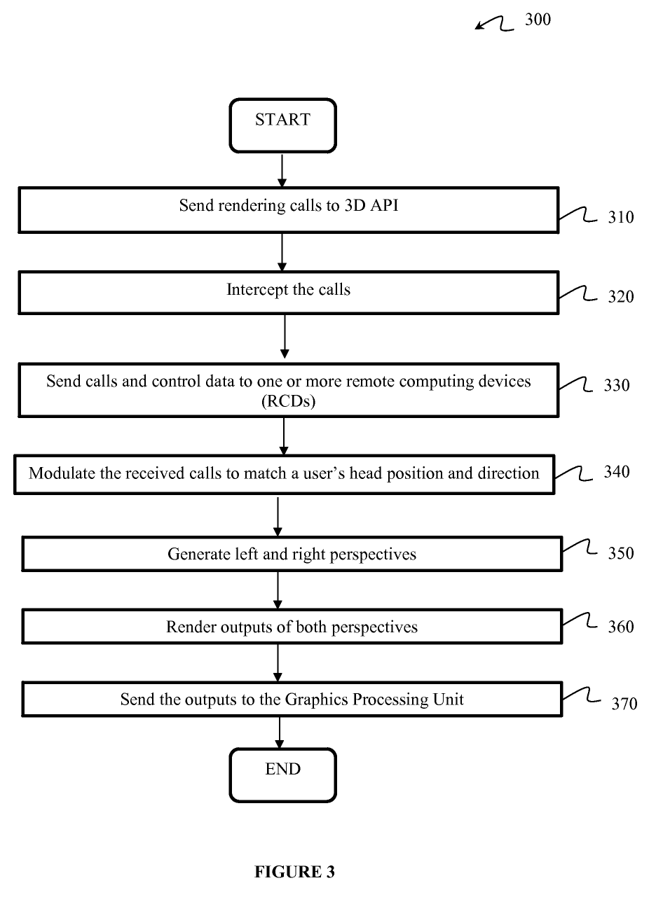

FIG. 3 is a flowchart depicting a process for converting application software graphics output into stereoscopic 3D, in accordance with embodiments of the present disclosure.

The flowchart 300 includes the following steps. In step 310, rendering calls are sent to the 3D API. In step 320, the calls are intercepted. In step 330, the calls and control data are sent to a remote computing device. The control data may be control instructions. In step 340, the received calls are modulated to match a user's head position and direction. In step 350, left and right perspectives are generated. Left and right perspectives are stereoscopic perspective views. In step 360, outputs of the left and right perspectives are rendered. In step 370, the outputs are sent to the graphics processing unit. The process then ends. It is to be understood that the method steps described herein need not necessarily be performed in the order as described. Further, words such as “thereafter,” “then,” “next,” etc., are not intended to limit the order of the steps. These words are simply used to guide the reader through the description of the method steps.

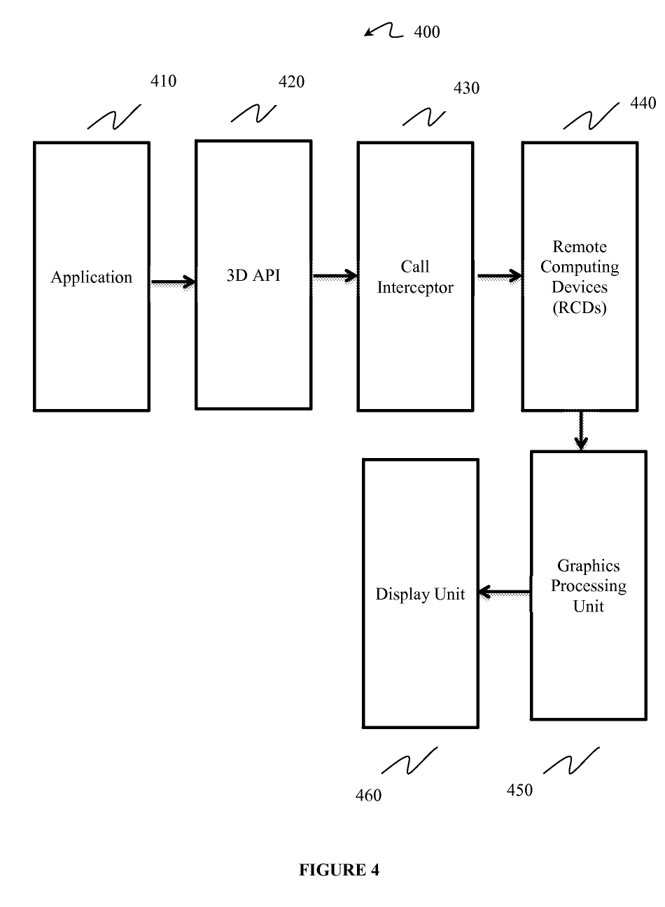

FIG. 4 is a block diagram for converting application software graphics output into stereoscopic 3D via an interceptor that transmits the calls to one or more remote computing devices, in accordance with embodiments of the present disclosure.

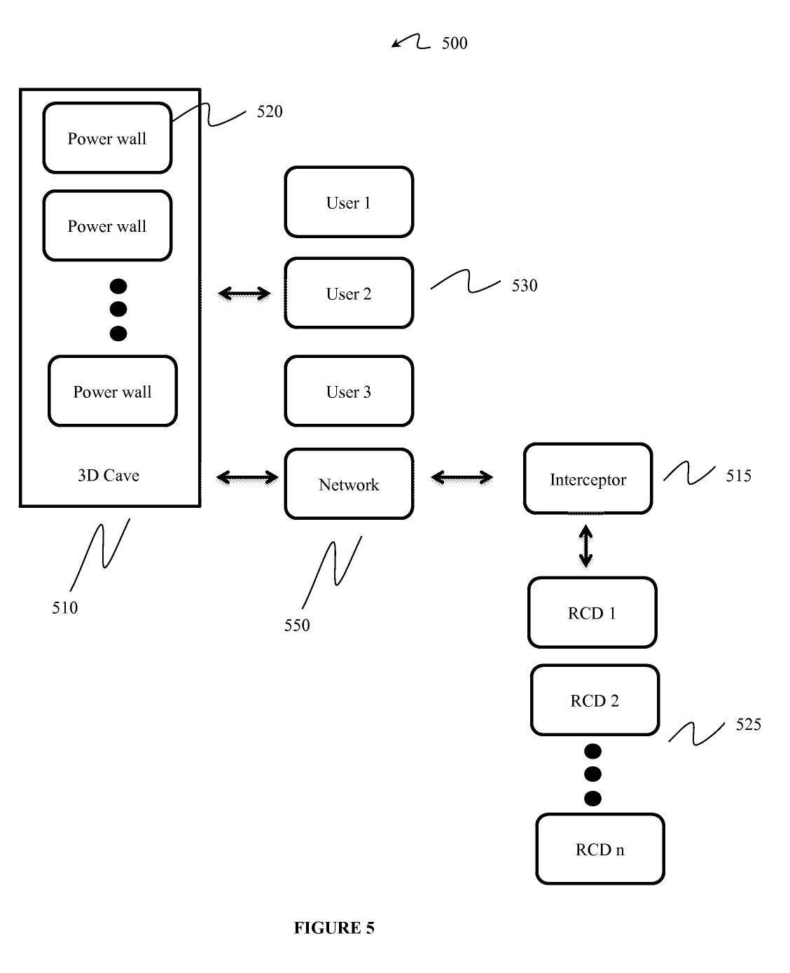

The block diagram 400 includes an application 410 for sending calls to 3D API 420. A call interceptor 430 intercepts the calls and sends them to one or more remote computing devices 440. The remote computing devices 440 process the calls. For example, the remote computing devices 440 modulate the calls to match a user's received head position and direction, as well as generate left and right perspectives, and render outputs of both perspectives. The outputs are then provided to the graphics processing unit 450, which in turn forwards such data or information to the display unit 460. The display unit 460 may be one or more power walls and/or a 3D cave, as discussed below with reference to FIG. 5.

FIG. 5 is a system illustrating a user within a 3D cave or facing one or more power walls, the system continuously tracking the user's head position and direction, and communicating with the remote computing devices via the interceptor, in accordance with embodiments of the present disclosure.

The system 500 includes a 3D cave 510. The 3D cave 510 may include one or more power walls 520. However, it is contemplated by one skilled in the art to only have one or more power walls 520. A plurality of users 530 view the one or more power walls 520 or enter into the 3D cave 510 in order to experience 3D representations of data or information. The 3D cave 510 and/or the one or more power walls 520 communicate with an interceptor 515 via a network 550. The interceptor 515 receives the calls and forwards the calls to the one or more remote computing devices 525. The calls may be processed by one RCD 525. However, it is also contemplated that different calls may be processed by different RCDs 525. Therefore, each RCD 525 may process different calls. The processed information or data is then sent back to the 3D cave 510 and/or the one or more power walls 520 via the network 550.

Network 550 may be a group of interconnected (via cable and/or wireless) computers, databases, servers, routers, and/or peripherals that are capable of sharing software and hardware resources between many users. The Internet is a global network of networks. Network 550 may be a communications network. Thus, network 550 may be a system that enables users of data communications lines to exchange information over long distances by connecting with each other through a system of routers, servers, switches, databases, and the like.

Network 550 may include a plurality of communication channels. The communication channels refer either to a physical transmission medium such as a wire or to a logical connection over a multiplexed medium, such as a radio channel. A channel is used to convey an information signal, for example a digital bit stream, from one or several senders (or transmitters) to one or several receivers. A channel has a certain capacity for transmitting information, often measured by its bandwidth. Communicating data from one location to another requires some form of pathway or medium. These pathways, called communication channels, use two types of media: cable (twisted-pair wire, cable, and fiber-optic cable) and broadcast (microwave, satellite, radio, and infrared). Cable or wire line media use physical wires of cables to transmit data and information. The communication channels are part of network 550.

A computer assisted virtual environment (e.g., 3D cave 510) is an immersive virtual reality environment where projectors are directed to three, four, five or six of the walls of a room-sized cube. Cave 510 is typically a video theater sited within a larger room. The walls of Cave 510 are typically made up of rear-projection screens or flat panel displays. The floor can be a downward-projection screen, a bottom projected screen or a flat panel display. The projection systems are very high-resolution due to the near distance viewing which requires very small pixel sizes to retain the illusion of reality. The user wears 3D glasses inside the cave 510 to see 3D graphics generated by the cave 510. People using the 3D cave 510 can see objects apparently floating in the air, and can walk around them, getting a proper view of what they would look like in reality. A user's movements are tracked by the sensors typically attached to the 3D glasses and the video continually adjusts to retain the viewer's perspective. Computers control both this aspect of the cave 510 and the audio aspect. There are typically multiple speakers placed at multiple angles in the cave 510, providing 3D sound to complement the 3D video.

A power wall is a high performance stereoscopic output screen that usually combines the images of multiple projectors. Additionally, the display hardware may be a number of wearable stereoscopic display devices worn by one or more users. The wearable devices may be eyeglass or eyewear devices. However, one skilled in the art may contemplate any type of wearable devices on any part of the human body.

The exemplary embodiment of the present disclosure may be used to drive multi-user head mounted displays with wearable personal computing devices. This would allow a group of users to see each other, and move if tracked, in any given 3D scene, that is originally rendered on any master computer. Additionally, the graphics calls may be compressed and sent over a network, such as the Internet, to multiple locations or PC clusters, thus enabling the simultaneous use of a plurality of 3D caves or viewing groups within the 3D caves.

Therefore, in summary, calls between a 3D API and a driver are intercepted by an interceptor that transmits such calls to one or more remote computing devices (RCDs) that process such data or information. The RCDs may include one or more servers and/or databases. The processed data or information is then forwarded back to the graphics processing unit, via a network, in order to display such data or information in 3D on one or more power walls and/or one or more 3D caves. Thus, a multi-channel rendering system is created. The 3D API may be, for example, OpenGL or DirectX.

The general features and aspects of the present disclosure remain generally consistent regardless of the particular purpose. Further, the features and aspects of the present disclosure may be implemented in system in any suitable fashion, e.g., via the hardware and software configuration of system or using any other suitable software, firmware, and/or hardware.

For instance, when implemented via executable instructions, various elements of the present disclosure are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media may include any medium that may store or transfer information.

The computer means or computing means or processing means may be operatively associated with the stereoscopic system, and is directed by software to compare the first output signal with a first control image and the second output signal with a second control image. The software further directs the computer to produce diagnostic output. Further, a means for transmitting the diagnostic output to an operator of the verification device is included. Thus, many applications of the present disclosure could be formulated. The exemplary network disclosed herein may include any system for exchanging data or transacting business, such as the Internet, an intranet, an extranet, WAN (wide area network), LAN (local area network), satellite communications, and/or the like. It is noted that the network may be implemented as other types of networks.

Additionally, “code” as used herein, or “program” as used herein, may be any plurality of binary values or any executable, interpreted or compiled code which may be used by a computer or execution device to perform a task. This code or program may be written in any one of several known computer languages. A “computer,” as used herein, may mean any device which stores, processes, routes, manipulates, or performs like operation on data. A “computer” may be incorporated within one or more transponder recognition and collection systems or servers to operate one or more processors to run the transponder recognition algorithms. Moreover, computer-executable instructions include, for example, instructions and data which cause a general purpose computer, special purpose computer, or special purpose processing device to perform a certain function or group of functions. Computer-executable instructions also include program modules that may be executed by computers in stand-alone or network environments. Generally, program modules include routines, programs, objects, components, and data structures, etc., that perform particular tasks or implement particular abstract data types.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present disclosure.

The foregoing examples illustrate various aspects of the present disclosure and practice of the methods of the present disclosure. The examples are not intended to provide an exhaustive description of the many different embodiments of the present disclosure. Thus, although the foregoing present disclosure has been described in some detail by way of illustration and example for purposes of clarity and understanding, those of ordinary skill in the art will realize readily that many changes and modifications may be made thereto without departing form the spirit or scope of the present disclosure.

While several embodiments of the disclosure have been shown in the drawings and described in detail hereinabove, it is not intended that the disclosure be limited thereto, as it is intended that the disclosure be as broad in scope as the art will allow. Therefore, the above description and appended drawings should not be construed as limiting, but merely as exemplifications of particular embodiments. Those skilled in the art will envision other modifications within the scope and spirit of the claims appended hereto.

What is claimed is:

1. A method of generating stereoscopic images, the method comprising:
receiving a call from an application programming interface (API) via at least one communication channel of a network;
intercepting the call, via the network;
transmitting the call to at least one remote computing device, via the network;
modulating the call to match a user's head position and direction;
generating left and right perspective views;
rendering outputs of the left and right perspective views; and
forwarding the outputs, via the network, to a graphics processing unit.

2. The method of claim 1, further comprising displaying the left and right perspective views on display hardware.

3. The method of claim 2, wherein the display hardware is at least one of a power wall and a 3D cave.

4. The method of claim 2, wherein the display hardware is a plurality of wearable stereoscopic display devices.

5. The method of claim 1, wherein the API is a three-dimensional API.

6. The method of claim 1, wherein the at least one remote computing device includes one or more processors.

7. The method of claim 1, wherein the call is transmitted to the at least one remote computing device with control data.

8. The method of claim 1, wherein the left and right perspective views are stereoscopic views.

9. The method of claim 8, wherein the call is transformed into calls for left and right edge blended stereoscopic views.

10. The method of claim 8, wherein the call is transformed into calls for left and right geometry warped stereoscopic views.

11. The method of claim 8, wherein the call is transformed into calls for left and right interleaved stereoscopic views.

12. The method of claim 8, wherein the call is transformed into calls for left and right stereoscopic views based on viewer location.

13. A system for generating stereoscopic images, the system comprising:
a network having one or more communication channels;
an application which generates monoscopic calls;
an application programming interface (API) for sending a call, via the network;
an intercepting module for intercepting the call, via the network;
at least one remote computing device for receiving the call from the intercepting module;
a modulator for modulating the call to match a user's head position and direction;
a processing module for generating left and right perspective views; and
an output module for rendering outputs of the left and right perspective views and forwarding the outputs, via the network, to a graphics processing unit.

14. The system of claim 13, further comprising displaying the left and right perspective views on display hardware.

15. The system of claim 14, wherein the display hardware is a power wall.

16. The system of claim 14, wherein the display hardware is a 3D cave.

17. The system of claim 14, wherein the display hardware is a plurality of wearable stereoscopic display devices.

18. The system of claim 13, wherein the API is a three-dimensional API.

19. The system of claim 13, wherein the call is transmitted to the at least one remote computing device with control data.

20. The system of claim 13, wherein the left and right perspective views are stereoscopic views.
